(19) United States
(12) Patent Application Publication
(10) Pub. No.: US 2011/0316798 A1
(43) Pub. Date: Dec. 29, 2011

(54) Tactile Display for Providing Touch Feedback

(76) Inventors: Warren Jackson, San Francisco, CA (US); Ping Mei, San Jose, CA (US)

(21) Appl. No.: 13/130,838

(22) PCT Filed: Feb. 26, 2010
(86) PCT No.: PCT/US10/25637

§ 371 Date: May 24, 2011

(51) Int. Cl. G06F 3/041

(52) U.S. Cl. 345/173

(57) ABSTRACT

A tactile display has a contact surface that has multiple addressable pixels. Each pixel has a vibration element that is energizable to vibrate at a selected frequency and amplitude. The vibration of selected pixels of the tactile display provides tactile feedback to a user's finger touching the contact surface.

### BACKGROUND

User interfaces for telecommunications and computerized devices traditionally have been focused on the visual and auditory human senses. Many televisions, computers and game stations have high-resolution visual displays and capabilities for stereo or multi-channel audio output. The other human senses, however, are largely ignored and not utilized in user interfaces. In particular, the sense of touch, which is a critical part of how people experience the world, is typically neglected in user interface designs. There have been some limited efforts in adding “touch” to user interfaces in relatively crude ways. For instance, to enhance the realism of computer games, some game controllers incorporate a motor with a rotating unbalanced load that shakes the hands of the player to indicate a collision or explosion. Also, it has be demonstrated that ultrasonic vibration of a glass plate can change the friction between a finger and the glass surface due to entrainment of air caused by the ultrasonic vibration. Attempts have been made to use temporal variations of such friction changes to mimic the sensation of feeling the texture of an object by touch.

### BRIEF DESCRIPTION. OF THE DRAWINGS

Some embodiments of the invention are described, by way of example, with respect to the following figures:

FIG. 1 is a schematic view of a tactile display constructed according to an embodiment of the invention for providing touch feedback to a user's hand;

FIG. 2 is a schematic top view of pixels of a contact surface of the tactile display of FIG. 1;

FIG. 3 is a schematic cross-sectional view of vibration elements of pixels in one embodiment of the tactile display;

FIG. 4 is a schematic cross-sectional view of vibration elements of pixels in another embodiment of the tactile display;

FIG. 5 is a schematic cross-sectional view of vibration elements of pixels in another embodiment of the tactile display;

FIG. 6 is a schematic cross-sectional view of vibration elements of pixels in yet another embodiment of the tactile display;

FIG. 7 is a schematic cross-sectional view of a user interface device that integrates a tactile display with a visual display; and

FIG. 8 is an illustration of the user interface device of FIG. 7 being used to provide both visual and tactile information of a displayed object.

### DETAILED DESCRIPTION

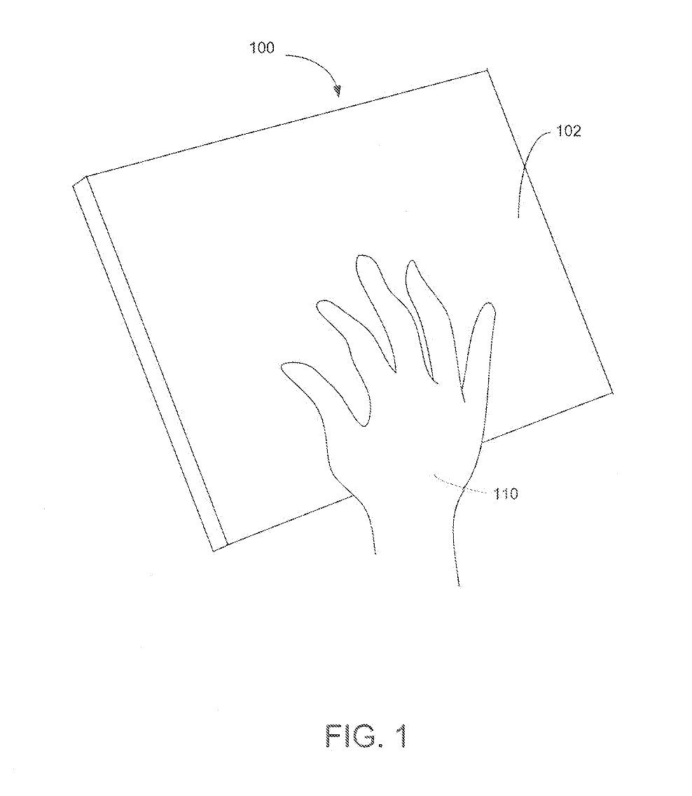

FIG. 1 shows an embodiment of a tactile display device 100 in accordance with the invention for providing tactile information to a user by touch. As used herein, the word “display” is used broadly to mean an output device that presents information for perception by a user, and such information may be visual, tactile or auditory. As described in greater detail below, the tactile display 100 has a tactile contact surface 102 that is capable of providing spatially and temporally varying touch sensations to the hand 110 of a user touching the surface. The spatial variation of the tactile information provided by the contact surface 102 not only allows the different fingers of the user to receive different tactile feedback, but also allows different parts of the contact area of each finger with the contact surface 102 to produce various touch sensations, much like the way a human finger senses the surface of a real object by touch.

The tactile feedback provided by the contact surface 102 enables many new ways of integrating the sense of touch in user interfaces for various applications to enrich the user experience. For example, when a user shops for clothing on the internet, information about the fabric used to make the clothing may be transmitted to the user's computer, which operates the contact surface 102 of the tactile display 100 such that the user can touch the surface and feel the texture of the fabric. As another example, for space or deep-sea explorations, visual and tactile information of a remote object collected by a robotic device can be transmitted to an observer to allow the observer to not only see the object but also touch the object by using the tactile display 100.

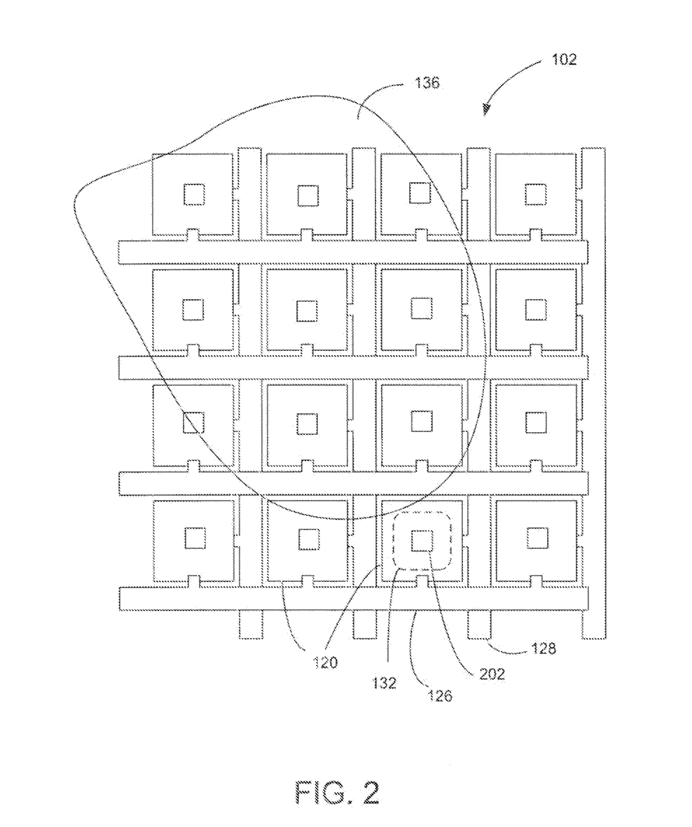

FIG. 2 shows an implementation of the tactile device 100 of FIG. 1. As shown in FIG. 2, the tactile contact surface 102, which may be generally planar, is divided into a plurality of pixels 120. As used herein, the word “pixel” is used to mean a tactile display element of the contact surface. As described in greater detail below, each pixel 120 has a vibration element capable of time varying displacements of varying frequency and amplitude, and the displacements of the top surface of the vibration element can move within the plane to provide shear displacements or normal to the display surface to provide normal displacements. The vibration of each pixel can be modulated separately from the vibration of the other pixels. To that end, the array of pixels 120 may be addressed using matrix addressing similar to that used in addressing the pixels of a visual display, such as an LCD display. As shown in FIG. 2, the pixels 120 may be arranged in a two-dimensional array and be connected by rows and columns of addressing lines or electrodes. Each pixel is addressed by selecting a row addressing line 126 and a column addressing line 128 connected to that pixel. In an active matrix configuration, the transistors and other parts of the drive circuitry 132 for energizing the vibration element of the pixel 120 may be fabricated under the vibration element. In a passive matrix configuration, the circuitry for energizing the vibration element of the pixel may be located away from the pixels, and the energy for actuating the vibration element of a pixel is provided to the pixel via the row and column addressing lines 126 and 128 of the pixel.

The dimensions of the pixels 120 may be selected depending on the desired spatial resolution of the tactile contact surface 102. In some embodiments, the pixel size may be selected to be similar to or smaller than the smallest spatial resolution of the somatic sensors on human fingers. Such resolution is around 0.5 mm. For example, in the embodiment of FIG. 2, the pixels may be about 0.3 mm in size. The high spatial resolution provided by the small pixel size allows the pixels of the contact surface 102 to provide sufficiently detailed tactile information to mimic the surface characteristics of a real object. As illustrated in FIG. 2, the contact area 136 of a finger of the user may cover multiple pixels 120. As the pixels can be individually addressed, each pixel can vibrate at different frequency and amplitude to generate its own “feel” of touch. The collection of multiple pixels in the contact area 120 can thus provide a rich spectrum of touch sensations. Moreover, as the user movers the fingers across the contact surface 120, the different touch sensations provided by the pixels of the surface can provide a realistic rendering of the feeling of touching the surface of a real object. In particular, if the positions of the fingers are tracked, appropriate time and space varying displacements can be imparted to the fingers and/or hand to mimic those displacements that would occur if the fingers were actually moving across a give object surface.

As mentioned above, each pixel 120 has a vibration element structured to generate the desired vibration frequency range and amplitude, which depend on the types of sensor cells intended to be stimulated by the vibration of the pixels. For example, the Merkel cells in a human finger, which are used for detecting form and texture, have a spatial resolution of about 0.5 mm, a sensing frequency range of 0-100 Hz with a peak sensitivity at 5 Hz, and a mean threshold of activation amplitude of 30 μm. In contrast, the Meissner cells in a human finger, which are used for motion detection and grip control, have a spatial resolution of 3 mm, a detection frequency range of 1-300 Hz with a peak sensitivity at 50 Hz, and a mean threshold of 6 μm, which is smaller than that of the Merkel cells. Other types of somatic sensors, such as the Pacinian and Ruffini cells, have their own respective, spatial resolutions, frequency ranges, and activation thresholds.

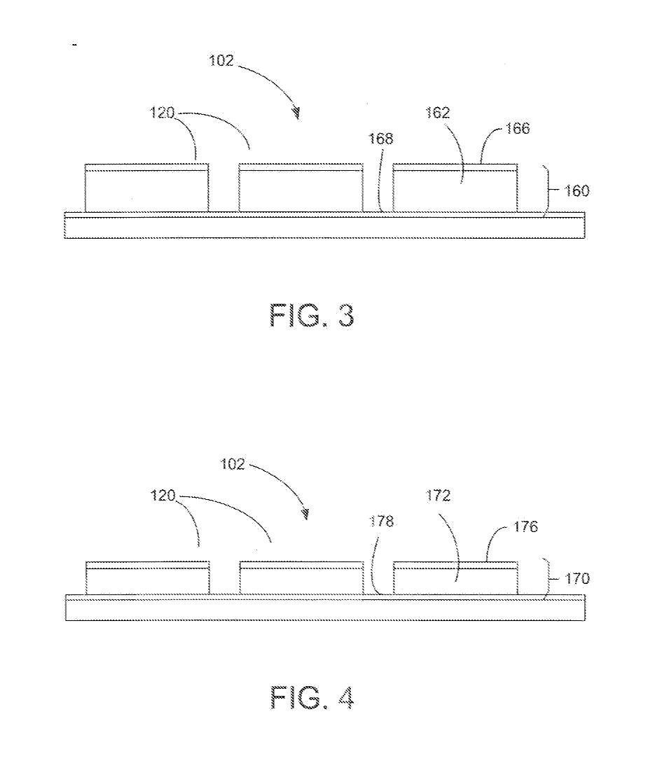

FIG. 3 shows the structure of the vibration elements of the pixels 120 in one embodiment of the tactile contact surface 102. In this embodiment, the pixels 120 are structured to provide relatively large displacement amplitudes, such as several microns to tens of microns, in a relatively low frequency range, such as 0-1000 Hz, to facilitate detection by the Merkel and/or Meissner cells in a human finger. The vibration element 160 of each pixel includes an actuator material 162, such as polyvinyl fluoride (PVF₂) or another type of electro-active polymer, disposed between two electrodes 166 and 168. The electro-active polymers (EAP) may be dielectric elastomers or ionic polymer metal composites. The electrodes 166, 168 may be the addressing lines in a passive matrix addressing configuration, or separate from the addressing lines when an active matrix addressing configuration is used.

FIG. 4 shows another embodiment of the pixels 120 of the tactile contact surface 102 that uses a different construction of the vibration elements. In this embodiment, the vibration elements 170 are to be operated at relatively high vibration frequencies, such as ultra-sonic frequencies. It has been shown that when a finger touches a surface that is vibrating at ultra-sonic frequencies, a layer of air may be entrained between the vibrating surface and the finger, thereby lowering the friction between the finger and the surface. In this embodiment, the pixels can be actuated to vibrate at different frequencies and amplitudes or be turned on and off independently. Thus, the friction can be different from one pixel to the adjacent pixel. The spatial and/or temporal variation of the friction as the user's finger move across the pixels may be interpreted as surface texture. By varying the frequencies and durations of the ultra-sonic vibration of the pixels, the contact surface can mimic the feel of the texture of a real object.

To generate vibration in the ultra-sonic frequency range, the vibration element 170 of each pixel 120 may use a poled piezoelectric material. The piezoelectric material layer 172 is disposed between two electrodes 176 and 178 for applying an AC voltage to actuate the piezoelectric material into vibration. Piezoelectric materials that may be used to form the layer 172 include zinc oxide (ZnO), lead zirconate titanate (PZT), barium titanate (BaTiO₃), sodium potassium niobate (NaKNb), etc. The piezoelectric material may also be a polymeric material, such as polyvinylidene fluoride (PVDF).

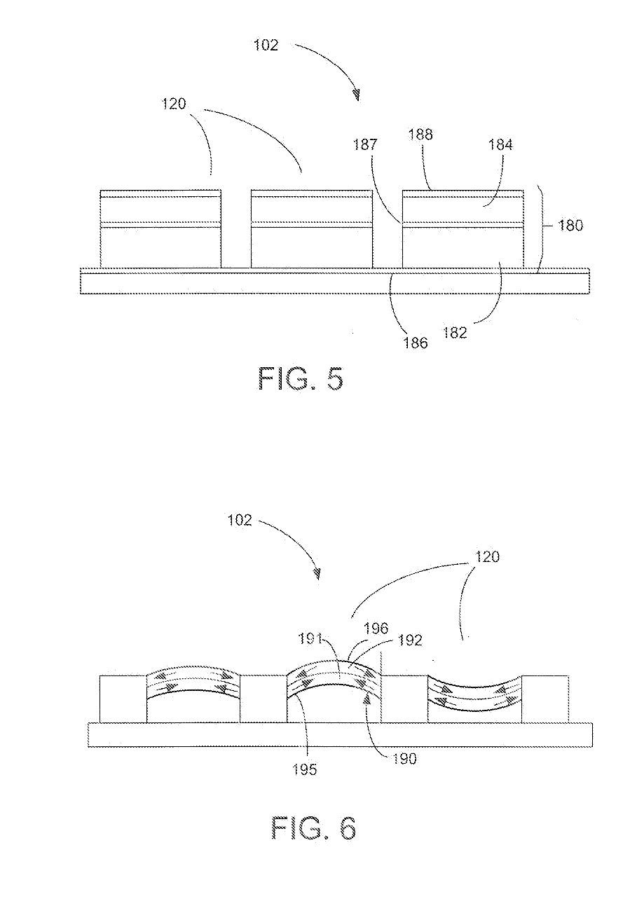

In another embodiment as shown in FIG. 5, the two types of actuation materials used in the embodiments of FIGS. 3 and 4 are combined. In this embodiment, the vibration element 180 of each pixel 120 has two layers. The lower layer 182 is for lower vibration frequencies, and uses a suitable actuation material, such as PVF2 or another electro-active polymer, disposed between the electrodes 186 and 187. The upper layer 184 is for ultra-sonic vibration frequencies and uses a piezoelectric material, such as ZnO or PZT, disposed between the electrodes 187 and 188. When both layers 182 and 184 are activated, the vibration state of the pixel 120 is a combination of the lower-frequency vibration and the ultrasonic vibration. The lower frequency vibration of the pixels with relatively high amplitude can be sensed by the somatic sensors in the finger, while the ultrasonic vibration modifies the friction between the finger and the pixels 120. By combining somatic sensing with friction modulation, the pixels of FIG. 5 are capable of providing a rich set of touch sensations to the user's finger.

FIG. 6 shows another embodiment that uses bending actuators as the vibration elements in the tactile pixels. As shown in FIG. 6, the vibration element 190 of each pixel 120 has two piezoelectric layers 191 and 192 that are bond together to form a bending actuator. The two piezoelectric layers 191 and 192 are arranged such that one layer expands in the planar direction while the other layer contracts in the planar direction when a voltage is applied to the electrodes 195 and 196. The expansion in one layer and contraction in another layer cause the bi-layer structure to buckle or curve. By alternating the polarity of the applied voltage, the vibration element 190 bends up and down in the normal direction of the tactile contact surface 102. Compared to the piezoelectric layer 172 in the embodiment of FIG. 4, the bending actuator is capable of significantly greater displacements. Thus, the vibration element 190 can be operated to vibrate at a frequency and amplitude detectable by the Merkel and Meissner cells in a user's finger touching the contact surface 102.

Returning to FIG. 2, in some embodiments, pixels 120 of the tactile contact surface 102 may be deactivated so that they do not vibrate when they are not touched. By not actuating pixels that not touched, both the audio noise and energy consumption of the tactile display device 100 can be substantially reduced. FIG. 2 shows one implementation of such control when an active matrix addressing arrangement is used to enable individual addressing of the pixels. The drive circuitry 132 of each pixel 120 includes a photosensitive switch 202, which may be in the form of a phototransistor or a combination of a photodiode and a transistor. When a pixel 120 is covered by a finger, ambient light to the pixel is cut off by the linger. As a result, the photosensitive switch 202 is switched on, allowing the drive circuitry 132 to operate to energize the vibration element of the pixel. When the pixel is not covered by a finger, the photosensitive switch 202 is exposed to the ambient light and thus switched off. As a result, the drive circuitry 132 is inactivated, and the pixel does not vibrate. The on-off states of the photosensitive switches 202 of the pixels 120 can also be used to determine the present location of the user's finger. This information can then be used to determine the movement of the finger as a function of time, so that the appropriate vibration patterns can be sent to the pixels to create the desired tactile feedback.

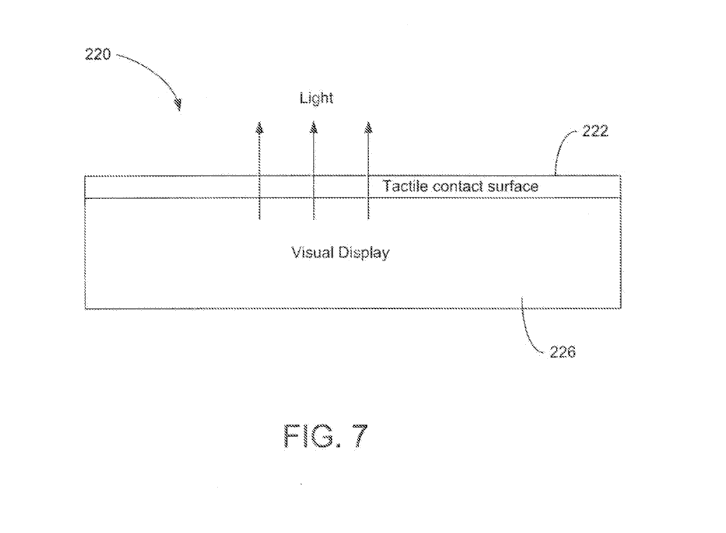

In the embodiments described above, the tactile contact surface 102 for touch feedback may be on a device 100 that is separate from the visual display of the user interface arrangement. FIG. 7 shows an embodiment in which a tactile display is integrated with a visual display to form one user interface device 220 that can offer visual and tactile information simultaneously. As shown in FIG. 7, a tactile contact surface 222 is laid over a visual display 226. For example, the visual display may be an LCD display, but other types of displays may also be used. Light generated by the visual display 226 is transmitted through the tactile contact surface 222 for viewing by a user. In the meantime, the pixels of the contact surface 222 may be actuated to provide tactile feedback to fingers of the user. To allow light generated by the visual display 226 to pass through the contact surface 222, the actuation materials of the vibration elements of the pixels of the contract surface may be formed of transparent materials. If active matrix addressing is used, the transistors for the driving the pixels may be transparent thin-film transistors formed of transparent materials, such as ZnO or ZnSnO. For either active matrix or passive matrix addressing configurations, the row and column addressing lines may have small widths to minimizes light blocking or be made of a transparent conductive oxide such as ZnO or InSnO.

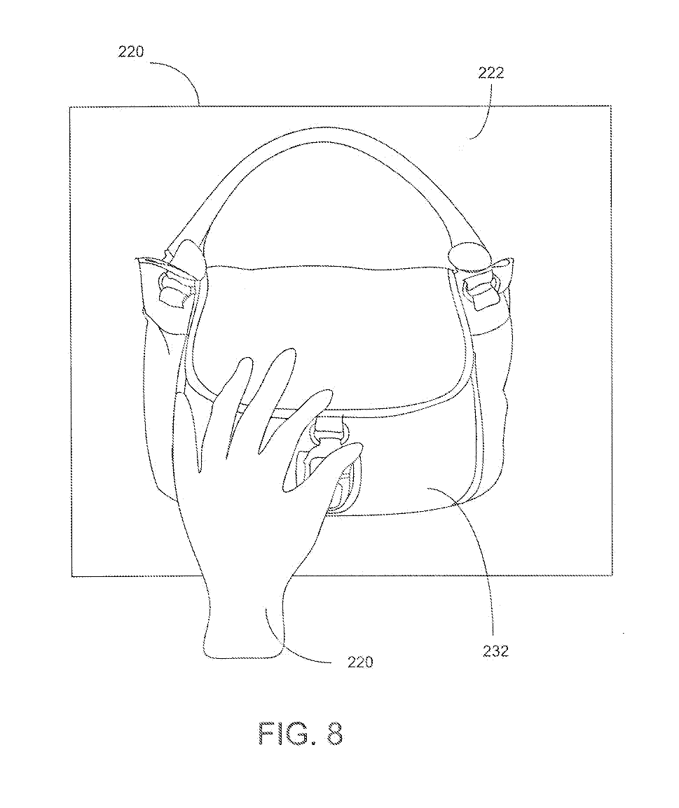

FIG. 8 illustrates a way the user interface device 220 may be advantageously used. When the visual display of the device 220 generates the image 232 of an object, the contact surface 222 that is laid over the visual display can be operated to provide tactile information regarding the object that corresponds directly to the image being displayed. In this way, the user can touch the displayed object image 232 and get tactile feedback regarding the object. For example, when a user shopping on the internet uses the device 220 to display an image of a leather handbag, the tactile information for the handbag can be downloaded to the user's computer and be used to actuate the contact surface 222. The user can then not only see the image of the handbag but also touch the image to sense the surface texture and shape of the handbag. Possible ways of utilizing this capability to “touch what you see” to enhance user interface experience are unlimited.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A user interface device for providing touch feedback, comprising:
a contact surface having a plurality of addressable pixels, each pixel having a vibration element energizable for generating vibration at a selected frequency and amplitude, the vibration of selected pixels of the contact surface providing tactile feedback to a user's finger touching the contact surface.

2. A user interface device in claim 1, wherein the vibration element generates vibration at a frequency detectable by somatic sensors of the user's finger.

3. A user interface device as in claim 2, wherein the vibration element includes a layer of electro-active polymer material.

4. A user interface device as in claim 1, wherein the vibration element includes an actuator for generating vibration at an ultra-sonic frequency.

5. A user interface device as in claim 1, wherein vibration element includes a bending actuator.

6. A user interface device as in claim 1, wherein the pixels are connected by row addressing lines and column addressing lines for active matrix addressing.

7. A user interface device as in claim 1, wherein each pixel has a drive circuit disposed under the vibration element, and the drive circuitry includes a photosensitive switch that turns off the drive circuit when the pixel is not covered so that the pixel does not vibrate.

8. A user interface device as in claim 1, wherein the pixels are connected by row addressing lines and column addressing lines for passive matrix addressing.

9. A user interface device of claim 1, wherein the vibration element of each pixel comprises a first actuator for vibrating at a first frequency range and a second actuator for vibrating at a second frequency range.

10. A user interface device as in claim 9, wherein the first actuator is for vibrating at an ultra-sonic frequency range and the second actuator is for vibrating at a frequency range detectable by somatic sensors in a human finger.

11. A user interface device as in claim 9, wherein the pixels have a size of 0.5 mm or less.

12. A user interface device comprising:
a visual display;
a tactile contact surface for proving touch feedback, the tactile contact surface being laid over the visual display and comprising a plurality of addressable pixels, each pixel having a vibration element energizable for vibrating at a selected frequency and amplitude, the vibration of selected pixels providing tactile feedback to a user's finger touching the contact surface.

13. A user interface device as in claim 12, wherein the vibration element comprises an actuator for vibrating at ultrasonic frequencies.

14. A user interface device as in claim 12, wherein the vibration element vibrates in at a frequency range and n amplitude detectable by somatic sensors in the user's finger.

15. A user interface device as in claim 12, wherein the vibration element includes a bending actuator.
